(19) United States
(12) Patent Application Publication
(10) Pub. No.: US 2012/0002921 A1
(43) Pub. Date: Jan. 5, 2012

(54) OPTICAL WAVEGUIDE ELEMENT, OPTICAL HYBRID CIRCUIT, AND OPTICAL RECEIVER

(75) Inventor: Seok-Hwan JEONG, Kawasaki (JP)

(73) Assignee: FUJITSU LIMITED, Kawasaki-shi (JP)

(21) Appl. No.: 13/157,394

(22) Filed: Jun. 10, 2011

(30) Foreign Application Priority Data
Jun. 30, 2010 (JP) 2010-149436

(51) Int. Cl. G02B 6/26

(52) U.S. Cl. 385/32

(57) ABSTRACT

An optical waveguide element includes a first optical coupler, a second optical coupler, and a first optical waveguide and a second optical waveguide that couple an output side of the first optical coupler and an input side of the second optical coupler to each other, the first optical waveguide and the second optical waveguide each include a bent waveguide, and the first optical waveguide and the second optical waveguide are different in optical path length from each other.

### CROSS-REFERENCE TO RELATED APPLICATIONS

This application is based upon and claims the benefit of priority from the prior Japanese Patent Application No. 2010-149436 filed on Jun. 30, 2010, the entire contents of which are incorporated herein by reference.

### FIELD

Embodiments of the present invention relate to an optical waveguide element, an optical hybrid circuit, and an optical receiver.

### BACKGROUND

In recent years, optical communication systems that enable high-speed and high-capacity information communication compared to electrical communication have been widely used. In the optical communication systems, an optical signal is occasionally split in order to perform various processes on the optical signal. In such a case, it is occasionally necessary to split the optical signal at a desired ratio, rather than to split the optical signal into equal parts. Conditions required for an element that splits and couples the optical signal (an optical splitting/coupling element) include a high fabrication tolerance of the optical splitting/coupling element. That is, if the manufacturing margin in manufacture of the optical splitting/coupling element is narrow, it may be difficult to obtain an optical splitting/coupling element with desired uniform characteristics, which may reduce yields or the like and increase the manufacturing cost.

An optical waveguide element including two optical waveguides that provide a phase difference between two 2×2 optical couplers has been reported as an optical splitting/coupling element that provides a desired optical splitting ratio. For example, as illustrated in FIG. 1, optical waveguides 613 and 614 provided between 2×2 optical couplers 611 and 612 each have a narrow section, and are different from each other in length of the narrow section or tapering shape for forming the narrow section. By thus providing the two optical waveguides 613 and 614 with different lengths of the narrow section etc., a phase difference can be caused between the two optical waveguides 613 and 614. Therefore, a desired optical splitting ratio can be obtained by adjusting the length of the narrow section etc. to vary the phase difference.

Meanwhile, as illustrated in FIG. 2, of optical waveguides 623 and 624 provided between 2×2 optical couplers 621 and 622, one optical waveguide 624 is provided with a narrow section, and the other optical waveguide 623 is not provided with such a section. Also in this case, a phase difference can be caused between the two optical waveguides 623 and 624, and a desired optical splitting ratio can be obtained by adjusting the length of the narrow section etc. to vary the phase difference.

Related techniques are disclosed in Japanese Laid-open Patent Publication No. 2004-144963 and Japanese Laid-open Patent Publication No. 2005-249973.

### SUMMARY

According to aspects of embodiments, an optical waveguide element includes a first optical coupler, a second optical coupler, and a first optical waveguide and a second optical waveguide that couple an output side of the first optical coupler and an input side of the second optical coupler to each other. The first optical waveguide and the second optical waveguide each include a bent waveguide, and the first optical waveguide and the second optical waveguide are different in optical path length from each other.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates the structure of an optical waveguide element;

FIG. 2 illustrates the structure of an optical waveguide element;

FIG. 3 illustrates the structure of an optical waveguide element;

FIG. 4 illustrates the structure of an optical waveguide element according to a first embodiment;

FIG. 5 illustrates the structure of another optical waveguide element according to the first embodiment;

FIG. 6 illustrates an offset point of an optical waveguide in an optical waveguide element;

FIG. 7 illustrates the structure of an optical waveguide element with an offset optical waveguide;

FIG. 8 illustrates the structure of the optical waveguide element according to the first embodiment with offset optical waveguides;

FIG. 9 illustrates the comparison between the offset and the transmittance for light;

FIG. 10 illustrates the structure of the optical waveguide in the optical waveguide element according to the first embodiment;

FIG. 11 illustrates another offset point of an optical waveguide in an optical waveguide element;

FIGS. 12A and 12B illustrate variations in width of an optical waveguide in an optical waveguide element;

FIG. 13 illustrates the comparison between variations in optical waveguide width and the transmittance for light;

FIG. 14 illustrates the structure of a 90-degree hybrid according to a second embodiment;

FIG. 15 illustrates the comparison between the wavelength and the transmittance for light in the 90-degree hybrid illustrated in FIG. 14;

FIG. 16 illustrates the comparison between the wavelength and the transmittance for light in the 90-degree hybrid illustrated in FIG. 17;

FIG. 17 illustrates the structure of a 90-degree hybrid including the optical waveguide element illustrated in FIG. 3;

FIG. 18 illustrates the dependence on the offset of the 90-degree hybrid illustrated in FIG. 14;

FIG. 19 illustrates the dependence on the offset of the 90-degree hybrid illustrated in FIG. 17;

FIG. 20 illustrates the dependence on variations in optical waveguide width of the 90-degree hybrid illustrated in FIG. 14;

FIG. 21 illustrates the structure of another 90-degree hybrid according to the second embodiment;

FIG. 22 illustrates the structure of another 90-degree hybrid according to the second embodiment;

FIG. 23 illustrates the structure of another 90-degree hybrid according to the second embodiment;

FIG. 24 illustrates the structure of an optical receiver according to a third embodiment;

FIG. 25 illustrates the structure of a 90-degree hybrid according to an fourth embodiment; and

FIG. 26 illustrates the structure of an optical receiver according to a fifth embodiment.

### DESCRIPTION OF EMBODIMENTS

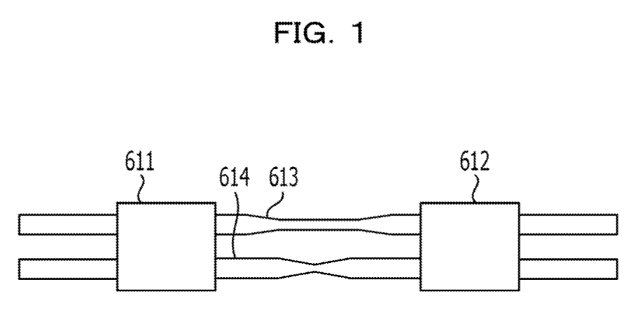

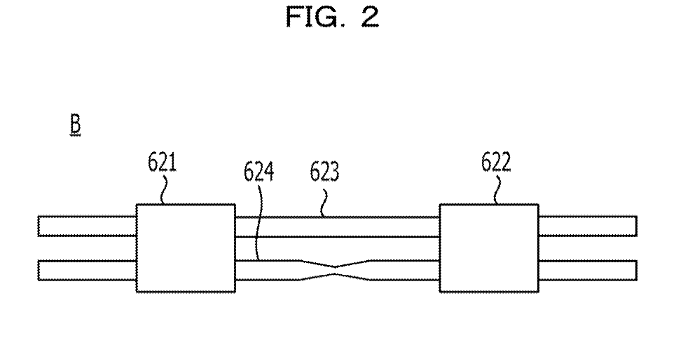

In the optical waveguide elements illustrated in FIGS. 1 and 2, if the width of an optical waveguide formed deviates from a design value, variations in phase caused at the narrow section of the optical waveguide may deviate from a desired value, as a result of which a desired splitting ratio may not be obtained. Specifically, the degree of deterioration in characteristics (FM₁) of the optical waveguide element structured as illustrated in FIG. 2 is represented by Formula 1 below. In the formula, k₀ indicates the wave number in a vacuum, L_{PS} indicates the length of the section with variations in phase, and δn₁ and δn₂ indicate variations in refractive index for variations in width between the two optical waveguides. Brackets < > indicate that the variations in refractive index may locally differ because the respective widths of the two optical waveguides are not constant.

FM₁∝k₀·( [symbol] δn₁ [symbol] − [symbol] δn₂ [symbol] )−L_{PS} [Formula 1]

As seen from Formula 1, it is preferable to reduce the value of (<δn₁>−<δn₂>) or the value of L_{PS} in order to mitigate the deterioration in characteristics with respect to variations in width between the optical waveguides. However, reducing one of the two parameters increases the other in order to obtain a desired phase difference, which sets a limit to increasing the fabrication tolerance.

Example embodiments will be explained with reference to accompanying drawings. Like members are denoted by like reference numerals and repetitive descriptions of the like members are omitted for the sake of brevity.

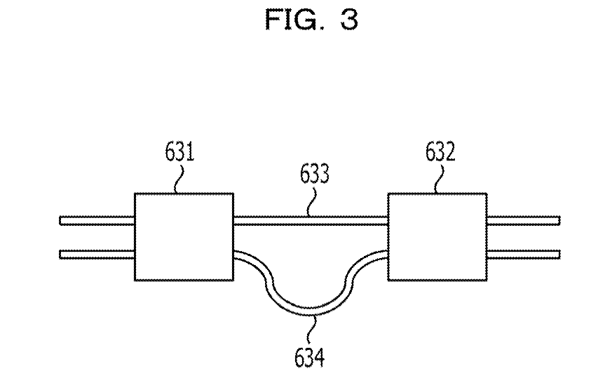

An optical waveguide element with a different structure from the structures illustrated in FIGS. 1 and 2 can also be considered. For example, as illustrated in FIG. 3, an optical waveguide element in which two optical waveguides 633 and 634 with the same width as each other are formed between 2×2 optical couplers 631 and 632 with one optical waveguide 633 formed to be straight and the other optical waveguide 634 formed to be bent to cause a phase difference. In this case, the degree of deterioration in characteristics (FM₂) of the optical waveguide element is represented by Formula 2. In the formula, k₀ indicates the wave number in a vacuum, n_{eq} indicates the effective refractive index of the optical waveguide, and ΔL_{PS} indicates the length of a waveguide with a delay (the difference in length between the optical waveguide 634 and the optical waveguide 633).

FM₂∝k₀·n_{eq}·ΔL_{PS} [Formula 2]

While the value of n_{eq} in Formula 2 is larger by about two orders of magnitude than the value of (<δn₁>−<δn₂>) in Formula 1, the value of ΔL_{PS} in Formula 2 is smaller by about three orders of magnitude than the value of L_{PS} in Formula 1. Therefore, FM₂ is smaller than FM₁. That is, the deterioration in characteristics of the optical waveguide element structured as illustrated in FIG. 3 is suppressed compared to the optical waveguide elements structured as illustrated in FIGS. 1 and 2. In the case of the optical waveguide element illustrated in FIG. 3, however, the propagation mode is controlled in the bent section of the optical waveguide 634. That is, mode fluctuations caused in the bent section of the optical waveguide 634 may result in a significant deviation from a desired phase difference, which makes stable use difficult.

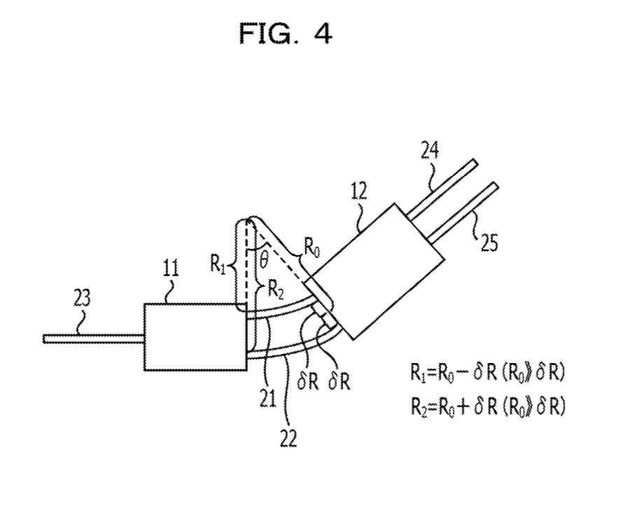

Next, an optical waveguide element according to a first embodiment will be described. As illustrated in FIG. 4, the optical waveguide element according to the embodiment includes a 1×2 Multi-Mode Interference (MMI) coupler 11, a 2×2 MMI coupler 12, and two optical waveguides 21 and 22 provided between the 1×2 MMI coupler 11 and the 2×2 MMI coupler 12. The 1×2 MMI coupler 11 serving as a first optical coupler splits light incident from an optical waveguide 23 into two parts to be emitted to the optical waveguide 21 serving as a first optical waveguide and the optical waveguide 22 serving as a second optical waveguide. The 2×2 MMI coupler 12 serving as a second optical coupler causes the parts of the light incident from the optical waveguides 21 and 22 to interfere with each other and to be emitted to optical waveguides 24 and 25. The optical waveguides 21 and 22 are bent in the same direction to be formed in an arcuate shape. Specifically, the optical waveguide 21 is bent with a radius of curvature of R₁, and the optical waveguide 22 is bent with a radius of curvature of R₂. The center of a circle drawn with the radius of curvature R₁ and including the optical waveguide 21 generally coincides with the center of a circle drawn with the radius of curvature R₂ and including the optical waveguide 22. The radii of curvature R₁ and R₂ are represented by Formula 3, where R₀ is an average value of the radii of curvature R₁ and R₂, which is referred to herein as an “average radius of curvature”. Therefore, both the optical waveguide 21 and the optical waveguide 22 have a bent waveguide, and the optical waveguide 21 and the optical waveguide 22 are different in optical path length from each other.

R₁=R₀−δR(R₀ [symbol] δR)

R₂=R₀+δR(R₀ [symbol] δR) [Formula 3]

On the assumption that the optical waveguides 21 and 22 coupled to the 1×2 MMI coupler 11 and the 2×2 MMI coupler 12 are formed in an arcuate area defined by the radii of curvature R₁ and R₂, respectively, and an angle θ, the difference in length between the optical waveguide 21 and the optical waveguide 22 is 2×θ×δR. Hence, a phase difference corresponding to the difference in length can be caused. That is, in the optical waveguides 21 and 22, a desired phase difference can be obtained by adjusting the angle θ and the radii of curvature R₁ and R₂. The degree of deterioration in characteristics of the thus formed optical waveguide element is similar to that indicated by Formula 2, and is small compared to those obtained in the cases illustrated in FIGS. 1 and 2. Because δR is extremely smaller than R₀ (average radius of curvature), It is considered that the propagation mode in the two optical waveguides 21 and 22 hardly depends on the radius of curvature.

The two optical waveguides 21 and 22 are formed to be bent similarly. Therefore, even in the case where mode fluctuations are caused, the two optical waveguides 21 and 22 are affected in the same way, and thus the phase difference between the optical waveguides 21 and 22 can be kept substantially constant. Hence, the two optical waveguides 21 and 22 are formed to extend over a short distance, affected by mode fluctuations only slightly, and thus can be used stably. The optical waveguides 21 and 22 are coupled to be substantially perpendicular to the 1×2 MMI coupler 11 and the 2×2 MMI coupler 12.

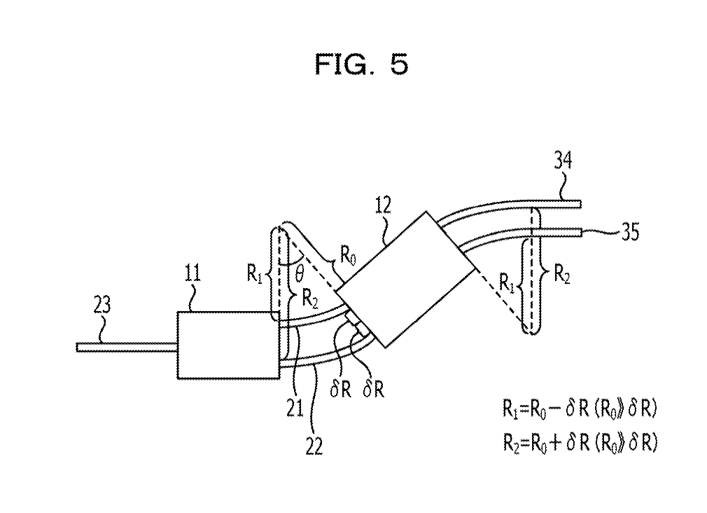

In FIG. 4, the optical waveguides 24 and 25 coupled to the output of the 2×2 optical coupler 12 are formed to be straight. However, as illustrated in FIG. 5, optical waveguides 34 and 35 coupled to the output of the 2×2 optical coupler 12 may be bent at radii of curvature R₂ and R₁, respectively, so that the optical waveguides 34 and 35 extend substantially in the same direction as the direction in which the optical waveguide 23 extends.

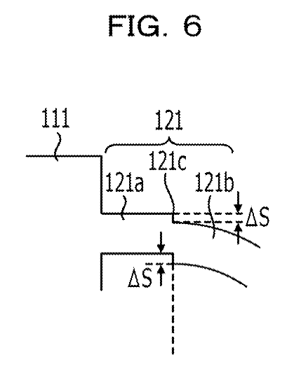

Next, the characteristics of the optical waveguide element according to the embodiment will be described. Normally, as illustrated in FIG. 6, when an optical waveguide 121 is coupled to an optical coupler 111 in an optical waveguide element, the optical waveguide 121 is formed by a straight waveguide 121a and a bent waveguide 121b with an offset section 121c provided between the straight waveguide 121a and the bent waveguide 121b. The electric field distribution of a mode propagated in the bent waveguide tends to be shifted toward the outer side of the bent waveguide, and therefore the value of the electric field distribution of a mode propagated in the straight waveguide does not match the value of the electric field distribution of the mode propagated in the bent waveguide, which may cause excess loss or mode fluctuations. Therefore, the offset section 121c is provided between the straight waveguide 121a and the bent waveguide 121b to provide a predetermined amount of offset in order to suppress the influence of the mode shift by intentionally offsetting the center of the straight waveguide 121a and the center of the bent waveguide 121b from each other. That is, the electric field distribution of the mode propagated in the bent waveguide 121b tends to be shifted toward the outer side of the bent waveguide 121b. Thus, the influence of the mode shift is suppressed by offsetting the bent waveguide 121b with respect to the straight waveguide 121a by a predetermined offset value ΔS. The offset section 121c is provided at the boundary section between the straight waveguide 121a and the bent waveguide 121b, and also referred to herein as a “stepped section”.

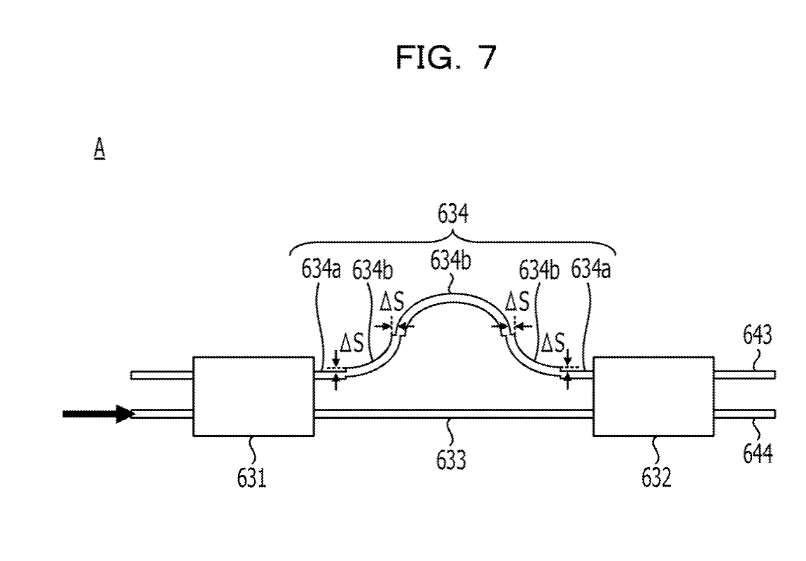

FIG. 7 illustrates a Mach-Zehnder interferometer which is formed by the optical waveguide element structured as illustrated in FIG. 3 and in which the optical waveguide 634 is offset. In the optical waveguide element structured as illustrated in FIG. 7, the optical waveguide 634 is formed by straight waveguides 634a and bent waveguides 634b, and each straight waveguide 634a and each bent waveguide 634b are offset from each other by ΔS. An offset point is provided at each inflection point between the bent waveguides 634b, and therefore a total of four offset points are provided.

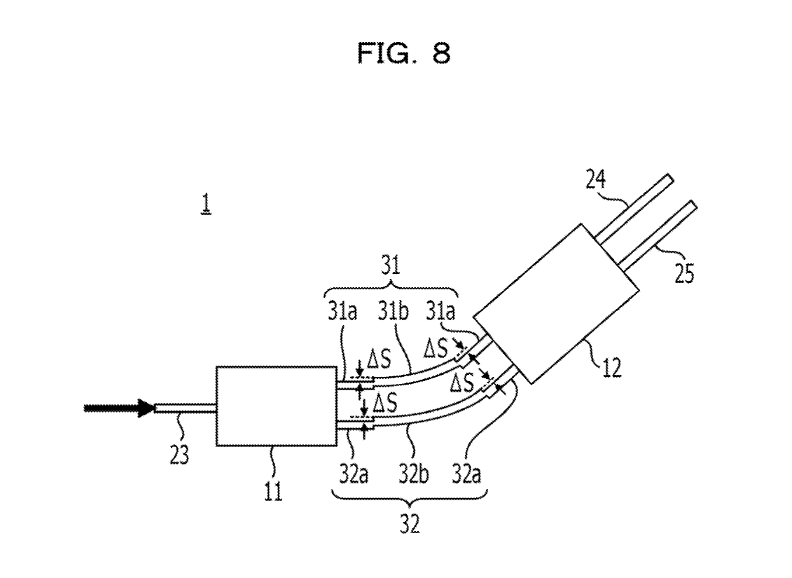

FIG. 8 illustrates a Mach-Zehnder interferometer which is formed by the optical waveguide element according to the embodiment and in which optical waveguides 31 and 32 are offset. That is, in the optical waveguide element structured as illustrated in FIG. 8, the optical waveguides 31 and 32 are formed by straight waveguides 31a and 32a and bent waveguides 31b and 32b, respectively, and the straight waveguides 31a and 32a and the bent waveguides 31b and 32b are offset from each other by ΔS, respectively. Hence, two offset points are provided in each of the optical waveguides 31 and 32.

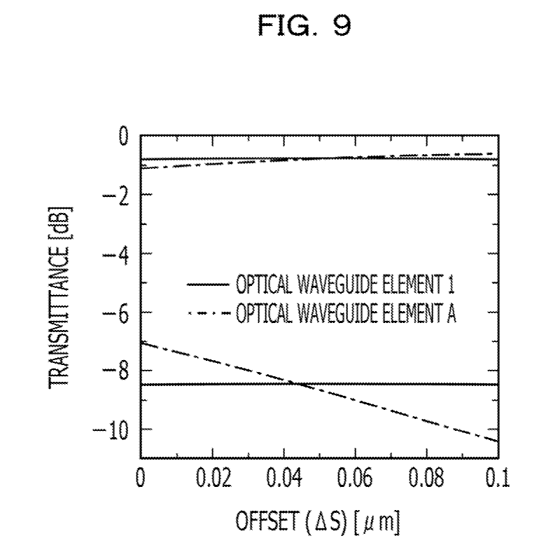

FIG. 9 illustrates the relationship between the offset value ΔS and the amount of split light to be output (transmittance for light) for the optical waveguide element illustrated in FIG. 7 (optical waveguide element A) and the optical waveguide element according to the embodiment illustrated in FIG. 8 (optical waveguide element 1). For the optical waveguide element A, the offset value ΔS is the value of the offset between each straight waveguide 634a and each bent waveguide 634b and the offset between the bent waveguides 634b. For the optical waveguide element 1, meanwhile, the offset value ΔS is the value of the offset between the straight waveguides 31a and 32a and the bent waveguides 31b and 32b, respectively.

The optical waveguide element A is formed such that the phase difference between the optical waveguide 634 and the optical waveguide 633 is −π/4, and the optical waveguide element 1 is formed such that the phase difference between the optical waveguide 31 and the optical waveguide 32 is −π/4. Accordingly, in design, the optical waveguide element A can split the optical output for the optical waveguide 634 and the optical waveguide 633 at 85 (loss of about 0.7 dB):15 (loss of about 8.3 dB), and the optical waveguide element 1 can split the optical output for the optical waveguide 31 and the optical waveguide 32 at 85:15.

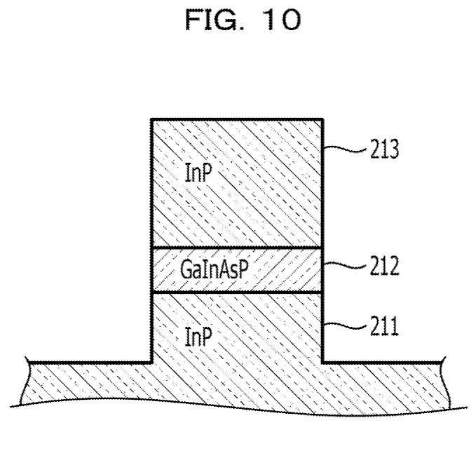

Further, as illustrated in FIG. 10, each of the optical waveguides in the optical waveguide element A and the optical waveguide element 1 is formed in a high-mesa waveguide structure. Specifically, a GaInAsP core layer 212 and an InP clad layer 213 are laminated on an InP substrate 211, and the GaInAsP core layer 212, the InP clad layer 213, and the InP substrate 211 are partially removed to form the high-mesa waveguide structure. The band-gap wavelength λ_{g} in the GaInAsP core layer 212 is 1.05 μm, and the width of both the formed optical waveguides is 2.5 μm, which satisfies conditions for a single mode. The optical waveguide element 1 is formed to have an R₀ of 500 μm and a δR of 1.5 μm.

As illustrated in FIG. 9, the optical waveguide element 1 according to the embodiment can split the optical output for the optical waveguide 31 and the optical waveguide 32 at 85:15 without dependence on the offset value ΔS. However, while the optical waveguide element A illustrated in FIG. 7 can split the optical output for the optical waveguide 643 and the optical waveguide 644 at 85:15 at an offset value ΔS of around 0.04 μm, variations in offset value ΔS also result in variations in splitting ratio. That is, for the optical waveguide element 1 according to the embodiment, the splitting ratio is generally constant at 85:15 in the case where the offset value ΔS is varied in the range of 0 to 0.1 μm. For the optical waveguide element A, in contrast, the amount of light split into the 85 part varies by about ±6%, and the amount of light split into the 15 part varies by about ±27%, as a result of which the splitting ratio varies depending on the offset value ΔS.

It is considered that the splitting ratio of the optical output varies significantly in the optical waveguide element A illustrated in FIG. 7 as described above because a higher-order mode or a higher-order leaky mode is excited in the bent waveguides to vary the amount of variations in phase due to ΔL_{PS}.

For the optical waveguide element 1 according to the embodiment illustrated in FIG. 8, on the other hand, the splitting ratio of the optical output hardly varies, and varies by ±1% or less, even if the offset value ΔS is varied in the range of 0 to 0.1 μm. This is considered to be because the optical waveguide 31 and the optical waveguide 32 are formed to include bent waveguides, the respective radii of curvature of which are extremely close to each other, and the same mode is excited in the optical waveguide 31 and the optical waveguide 32 although a higher-order mode or a higher-order leaky mode is excited in the bent waveguides. This is considered to result in maintenance of a predetermined amount of variations in phase in the optical waveguide 31 and the optical waveguide 32, which makes it possible to keep a substantially constant splitting ratio of the optical output.

In the optical waveguide element according to the embodiment, as described above, the splitting ratio of the optical output can be kept constant without dependence on the offset value ΔS between the straight waveguide and the bent waveguide, and the splitting ratio of the optical output is not affected even if the offset value ΔS deviates during manufacture. In the optical waveguide element according to the embodiment, further, it is not necessary to provide an offset section between the straight waveguide and the bent waveguide since the splitting ratio of the optical output does not depend on the offset value ΔS.

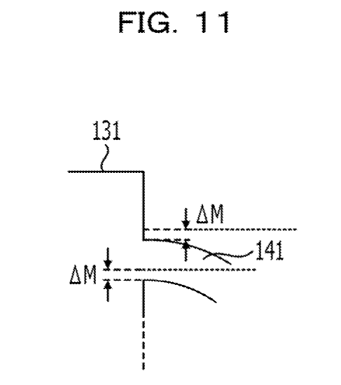

In the above description, an optical waveguide is formed by a straight waveguide and a bent waveguide. However, a case where an optical waveguide 141 is formed only by a bent waveguide and coupled to a coupler 131 as illustrated in FIG. 11 can be addressed in the same way. Specifically, in the case where the optical waveguide 141 and the coupler 131 are coupled to each other at a position offset by ΔM from a predetermined position, ΔM can be considered in the same way as the offset value ΔS. That is, in the optical waveguide element according to the embodiment, it is possible to obtain a desired splitting ratio of the optical output and to ensure a wide manufacturing margin even if the optical waveguide 141 and the coupler 131 are coupled to each other at a more or less offset position because of a manufacturing error or the like.

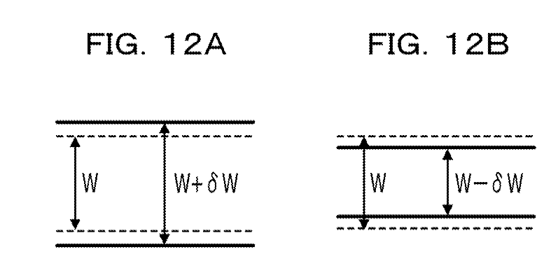

Next, a case where the width of an optical waveguide formed is varied under the influence of a manufacturing error or the like will be described with reference to FIGS. 12A and 12B. In such a case, an optical waveguide 151a may be formed to have a width W+δW, which is larger than a width W as the design value as illustrated in FIG. 12A, and an optical waveguide 151b may be formed to have a width W−δW, which is smaller than the width W as the design value, under the influence of a manufacturing error or the like.

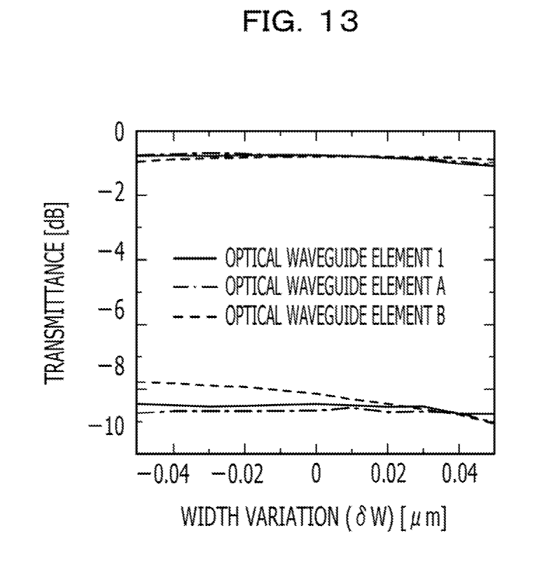

The relationship between the width of an optical waveguide and a split optical output will be described with reference to FIG. 13. As discussed above, the optical waveguide element 1 is the optical waveguide element according to the embodiment, and the optical waveguide element A is the optical waveguide element structured as illustrated in FIG. 7. An optical waveguide element B is the optical waveguide element structured as illustrated in FIG. 2. The optical waveguide element 1, the optical waveguide element A, and the optical waveguide element B are each formed to have a splitting ratio of the optical output of 85:15. In the case where δW is varied in the range of −0.05 to 0.05 μm as illustrated in FIG. 13, the variation rate of the optical output at an output port for the 15 part is ±11% for the optical waveguide element B, and about ±2.5% for the optical waveguide element A. In contrast, the variation rate of the optical output for the optical waveguide element 1 is about ±2.5% or less. Thus, the optical waveguide element 1 according to the embodiment is not significantly affected by a deviation in width of an optical waveguide formed, and the optical output can be split at a desired splitting ratio. In other words, the optical output of the optical waveguide element 1 can be split at a desired splitting ratio even in the case where an optical waveguide is formed to have a more or less large or small width because of a manufacturing error or the like. Because the optical waveguide element 1 according to the embodiment is not easily affected by a manufacturing error or the like in width of an optical waveguide as described above, a wide manufacturing margin can be ensured.

In the above description, the phase difference between two optical waveguides provided between two MMI couplers in an optical waveguide element is −π/4. However, the phase difference may be set to a desired value in the optical waveguide element according to the embodiment. Thus, it is possible to increase the manufacturing margin and to drastically improve the fabrication tolerance in the same way as described above even with a desired phase difference.

In the embodiment, the optical waveguides 21 and 22 provided between the 1×2 optical coupler 11 and the 2×2 optical coupler 12 are formed as arcs forming part of concentric circles. However, such a structure is not limiting. For example, as discussed above, the optical waveguides 21 and 22 may be structured by coupling a straight waveguide, a bent waveguide, and a straight waveguide in series, or may be structured by coupling a bent waveguide, a straight waveguide, and a bent waveguide in series.

The optical waveguides 21 and 22 may not necessarily be formed to have a constant width, and may be formed to become wider or narrower from one of the 1×2 optical coupler 11 and the 2×2 optical coupler 12 toward the other.

In the embodiment, further, the value of R₀ is 500 μm. However, a similar effect can be obtained with any value of R₀ that is 100 μm or more. That is, as the value of R₀ becomes smaller, the respective radii of curvature of the bent waveguides become smaller, and the optical waveguides may be bent so sharply that the same mode may not be excited in both the optical waveguides. In such a case, it may be difficult to obtain an optical waveguide element that is stable against the influence of a manufacturing error or the like, and the optical waveguide element may be easily affected by a slight manufacturing error or the like. Hence, in order to obtain a sufficient manufacturing margin and a desired fabrication tolerance, the value of the average radius of curvature R₀ is preferably 100 μm or more.

Next, a method of manufacturing the optical waveguide element according to the embodiment will be described with reference to FIG. 10.

First, an undoped GaInAsP core layer 212 and an InP clad layer 213 are formed on an InP substrate 211 by epitaxial growth by a Metal-Organic Vapor Phase Epitaxy (MOVPE) method. The InP substrate 211 is made of n-type or undoped InP. The formed GaInAsP core layer 212 has a band-gap wavelength of 1.05 μm and a film thickness of 0.5 μm, for example. The formed InP clad layer 213 is made of n-type or undoped InP, and has a film thickness of 2.0 μm.

Next, an SiO₂ film is formed on the InP clad layer 213 by Chemical Vapor Deposition (CVD) or the like. Further, a photoresist is applied onto the SiO₂ film, exposed to light by an exposure apparatus using a photomask, and developed to form a resist pattern. The resist pattern is formed in a waveguide area of the optical waveguide element. Thereafter, the SiO₂ film in an area in which the resist pattern is not formed is removed by dry etching such as Reactive Ion Etching (RIE) to form an SiO₂ mask (not shown).

Next, the InP clad layer 213, the GaInAsP core layer 212, and the InP substrate 211 in an area in which the SiO₂ mask is not formed are partially removed by dry etching such as Inductive Coupled Plasma-RIE (ICP-RIE). In this way, a high-mesa waveguide structure with a height of about 3.0 μm is formed.

In the above description, an InP-based compound semiconductor material is used. However, a similar optical waveguide element can be manufactured using a GaAs-based compound semiconductor material, an Si-based semiconductor material, a dielectric material, a polymer material, or the like.

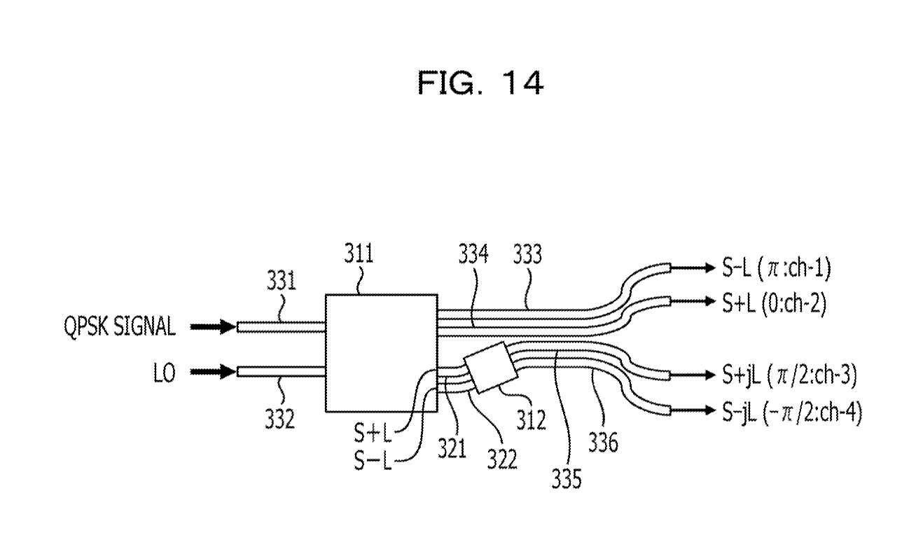

Next, a second embodiment will be described. The embodiment provides a 90-degree hybrid serving as an optical hybrid circuit including an optical waveguide element structured in the same way as the optical waveguide element according to the first embodiment. FIG. 14 illustrates the 90-degree hybrid according to the embodiment.

The 90-degree hybrid according to the embodiment includes a 2×4 MMI coupler 311, a 2×2 MMI coupler 312, and optical waveguides 321 and 322 provided between the 2×4 MMI coupler 311 and the 2×2 MMI coupler 312. The optical waveguides 321 and 322 are formed to be structured in the same way as the optical waveguides 21 and 22, respectively, according to the first embodiment.

In the 90-degree hybrid according to the embodiment, two optical waveguides 331 and 332 serving as a third optical waveguide and a fourth optical waveguide, respectively, are coupled to the input side of the 2×4 MMI coupler 311 serving as a first optical coupler. Quadrature phase shift keying (QPSK) signal light is input to the optical waveguide 331. Local oscillator (LO) light is input to the optical waveguide 332. The quadrature phase shift keying signal input into the optical waveguide 331 contains four signals including a reference signal (with a phase difference of 0) and respective signals with phase differences of π/2, π, and −π/2. When the signal lights are input to the optical waveguides 331 and 332, the 2×4 MMI coupler 311 splits the signal lights into four signal lights, which are output to four optical waveguides 333, 334, 321, and 322 coupled to the 2×4 MMI coupler 311. Herein, the optical waveguides 333 and 334 serve as a fifth optical waveguide and a sixth optical waveguide, respectively, and the optical waveguides 321 and 322 serve as the first optical waveguide and the second optical waveguide, respectively. Specifically, a signal with a phase difference of π is output to the optical waveguide 333, a signal with no phase difference is output to the optical waveguide 334, a signal with no phase difference is output to the optical waveguide 321, and a signal with a phase difference of π is output to the optical waveguide 322. Hence, two In-phase signals are output from the 2×4 MMI coupler 311. In the 90-degree hybrid according to the embodiment, the optical waveguide 321 and the optical waveguide 322 are coupled to the 2×2 MMI coupler 312, and the optical waveguide 322 is formed to be longer than the optical waveguide 321 so as to be delayed by a phase difference of π/4. This allows Quadrature to be output to the optical waveguides 335 and 336 coupled to the 2×2 MMI coupler 312 and serving as a seventh optical waveguide and an eighth optical waveguide, respectively. That is, a signal with a phase difference of π/2 is output to the optical waveguide 335, and a signal with a phase difference of −π/2 is output to the optical waveguide 336. In the 2×4 MMI coupler 311, the optical waveguide 321 serving as the first optical waveguide is provided on the inner side with respect to the optical waveguide 322 serving as the second optical waveguide, and the optical waveguide 322 is formed to be longer than the optical waveguide 322 so as to cause a phase difference of π/4. The phase difference may be (2n+¼)π (n is 0 or a natural number), which results in a phase difference of π/4.

Thus, in-phase signals may be output from the optical waveguides 333 and 334 as discussed above, and quadrature signals may be output from the optical waveguides 335 and 336. In the optical waveguide element according to the embodiment, an optical signal output from the optical waveguides 333 and 334 is referred to as an “I (In-phase) channel”, and an optical signal output from the optical waveguides 335 and 336 is referred to as a “Q (Quadrature) channel”.

If the optical waveguides 321 and 322 are formed with a deviation from a predetermined value under the influence of a manufacturing error or the like, deterioration in characteristics may be caused in orthogonal signal components. However, the 90-degree hybrid according to the embodiment includes an optical waveguide element structured in the same way as that according to the first embodiment. Therefore, it is possible to suppress deterioration in characteristics due to the influence of a manufacturing error or the like to a low level and to ensure a wide manufacturing margin.

Next, the characteristics of the 90-degree hybrid according to the embodiment will be described. In order to process an optical signal without an error, it is normally required to suppress a common-mode rejection ratio (CMRR) at the reception of the optical signal to 20 dB or less. In order to obtain a CMRR of 20 dB or less, it is necessary to suppress a deviation between the I channel and the Q channel in the 90-degree hybrid to 0.9 dB or less. If variations in reception sensitivity are to be considered, a higher accuracy is generally required for the deviation between the I channel and the Q channel of the 90-degree hybrid.

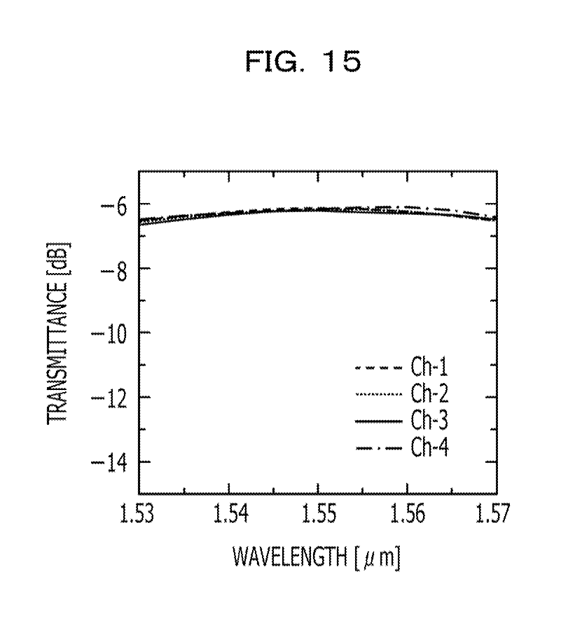

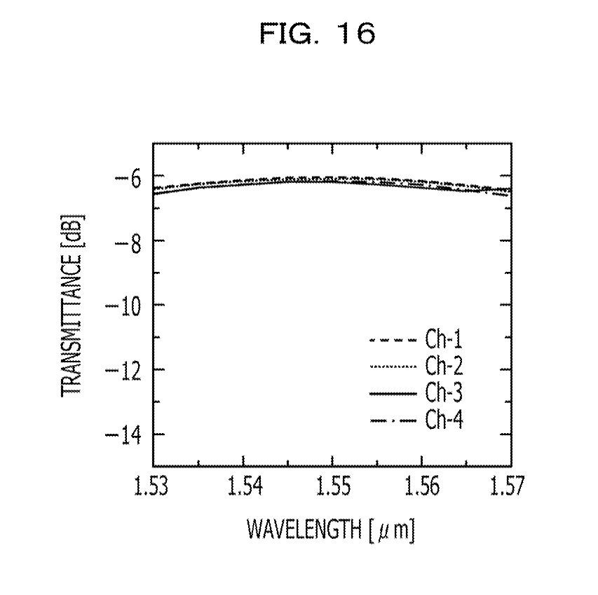

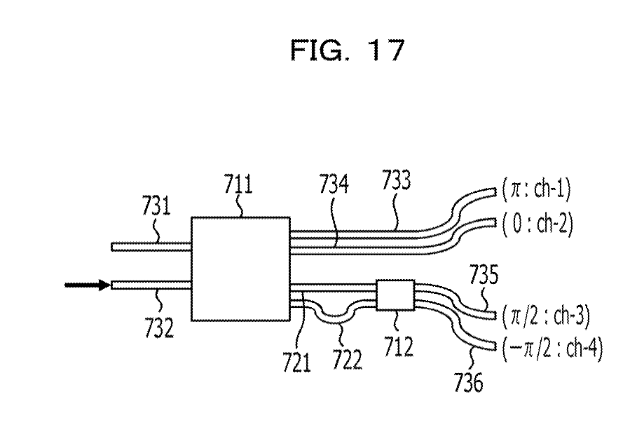

FIG. 15 illustrates the relationship between the wavelength and the transmittance for light in the 90-degree hybrid according to the embodiment illustrated in FIG. 14. FIG. 16 illustrates the relationship between the wavelength and the transmittance for light in a 90-degree hybrid structured as illustrated in FIG. 17. The relationship of FIG. 15 is obtained by inputting light only to the optical waveguide 332, without inputting light to the optical waveguide 331, in the 90-degree hybrid according to the embodiment illustrated in FIG. 14. Outputs from the optical waveguides 333, 334, 335, and 336 in this case are indicated as Ch-1, Ch-2, Ch-3, and Ch-4, respectively. The 90-degree hybrid structured as illustrated in FIG. 17 includes the optical waveguide element illustrated in FIG. 3. That is, the 90-degree hybrid structured as illustrated in FIG. 17 includes a 2×4 MMI coupler 711, a 2×2 MMI coupler 712, and optical waveguides 721 and 722 provided between the 2×4 MMI coupler 711 and the 2×2 MMI coupler 712. The optical waveguides 721 and 722 are formed to be structured in the same way as the optical waveguides 633 and 634, respectively, illustrated in FIG. 3. In the 90-degree hybrid illustrated in FIG. 17, optical waveguides 731 and 732 are coupled to the input side of the 2×4 MMI coupler 711, and optical waveguides 721, 722, 733, and 734 are coupled to the output side of the 2×4 MMI coupler 711. Also, the optical waveguides 721 and 722 are coupled to the input side of the 2×2 MMI coupler 712, and optical waveguides 735 and 736 are coupled to the output side of the 2×2 MMI coupler 712. For the optical waveguides formed in the 90-degree hybrid structured as illustrated in FIG. 17, the offset value ΔS has been optimized. The relationship of FIG. 16 is obtained by inputting light only to the optical waveguide 732, without inputting light to the optical waveguide 731, in the 90-degree hybrid structured as illustrated in FIG. 17. Outputs from the optical waveguides 733, 734, 735, and 736 in this case are indicated as Ch-1, Ch-2, Ch-3, and Ch-4, respectively.

In the 90-degree hybrid according to the embodiment illustrated in FIG. 14 and the 90-degree hybrid structured as illustrated in FIG. 17, all the optical waveguides are formed to have a high-mesa structure such as that illustrated in FIG. 10. That is, the optical waveguides have a high-mesa structure formed by forming the GaInAsP core layer 212 with a band-gap wavelength λ_{g} of 1.05 μm, and further the InP clad layer 213, on the InP substrate 211, and performing dry etching or the like.

As illustrated in FIGS. 15 and 16, it is confirmed that both the 90-degree hybrids exhibit a favorable splitting ratio and a small channel imbalance.

Next, a case where the offset value ΔS defined as illustrated in FIG. 6 is varied in the 90-degree hybrid according to the embodiment illustrated in FIG. 14 and the 90-degree hybrid structured as illustrated in FIG. 17 will be described.

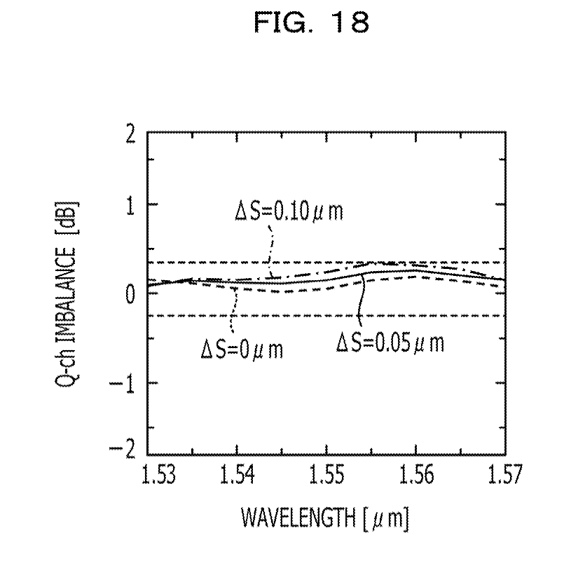

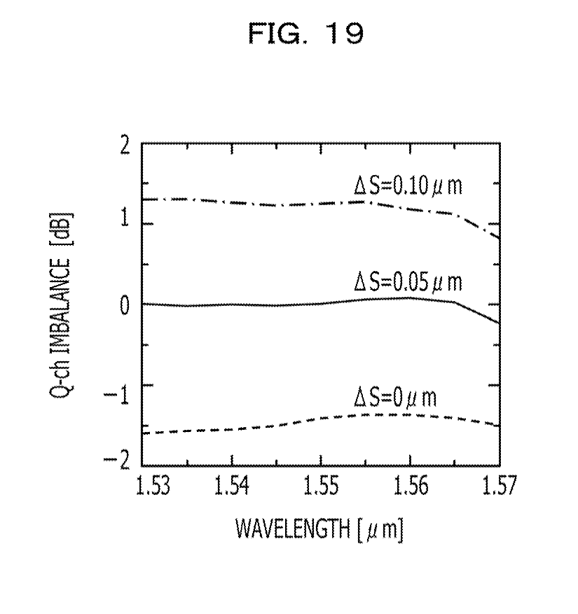

FIG. 18 illustrates the wavelength and the Q-channel imbalance in the case where the offset value ΔS is varied in the 90-degree hybrid according to the embodiment illustrated in FIG. 14. FIG. 19 illustrates the wavelength and the Q-channel imbalance in the case where the offset value ΔS is varied in the 90-degree hybrid illustrated in FIG. 17. In the 90-degree hybrid according to the embodiment, as illustrated in FIG. 18, the Q-channel imbalance falls within the range of ±0.3 dB or less even in the case where the offset value ΔS varies in the range of 0 to 0.1 μm. On the other hand, in the 90-degree hybrid structured as illustrated in FIG. 17, as illustrated in FIG. 19, the Q-channel imbalance varies significantly by ±1 dB or more in the case where the offset value ΔS varies in the range of 0 to 0.1 μm. In the 90-degree hybrid according to the embodiment, as discussed above, even if mode fluctuations are caused, the optical waveguides 321 and 322 are hardly affected, and therefore the Q-channel imbalance may be kept generally constant.

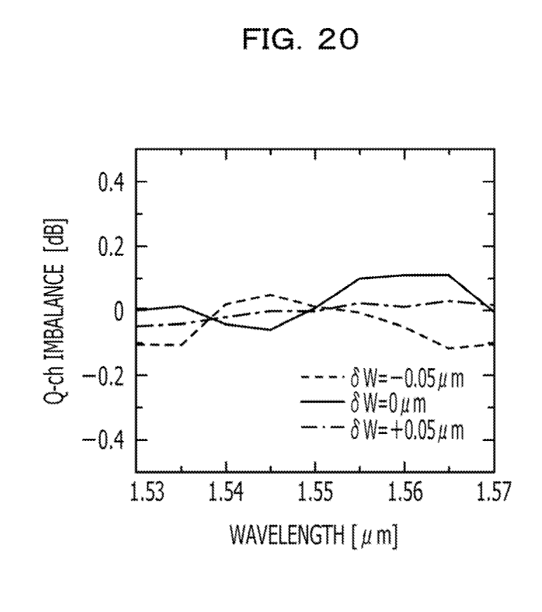

Next, a case where the width of an optical waveguide in the 90-degree hybrid according to the embodiment illustrated in FIG. 14 is varied as illustrated in FIG. 12 will be described. FIG. 20 illustrates the wavelength and the Q-channel imbalance in the case where a deviation amount δW with respect to the predetermined width W is varied in the range of −0.05 μm to 0.05 μm in the 90-degree hybrid according to the embodiment illustrated in FIG. 14. As illustrated in FIG. 20, the Q-channel imbalance falls within the range of ±0.15 dB or less even if the deviation amount δW with respect to the width W of the optical waveguides varies in the range of −0.05 μm to 0.05 μm, and thus is small.

From the above description, in the 90-degree hybrid according to the embodiment, even if the offset value ΔS and the width W of an optical waveguide are more or less different from the respective predetermined values because of a manufacturing error or the like, the characteristics are hardly varied under the influence of the manufacturing error or the like, and a wide manufacturing margin can be ensured. Hence, the fabrication tolerance can be drastically improved. In the 90-degree hybrid according to the embodiment, further, the splitting ratio of the optical signal does not depend on the offset value ΔS, and therefore it is not necessary to provide an offset section.

Next, modifications of the embodiment will be described. According to the modifications described below, as with the 90-degree hybrid discussed above, the fabrication tolerance can be drastically improved.

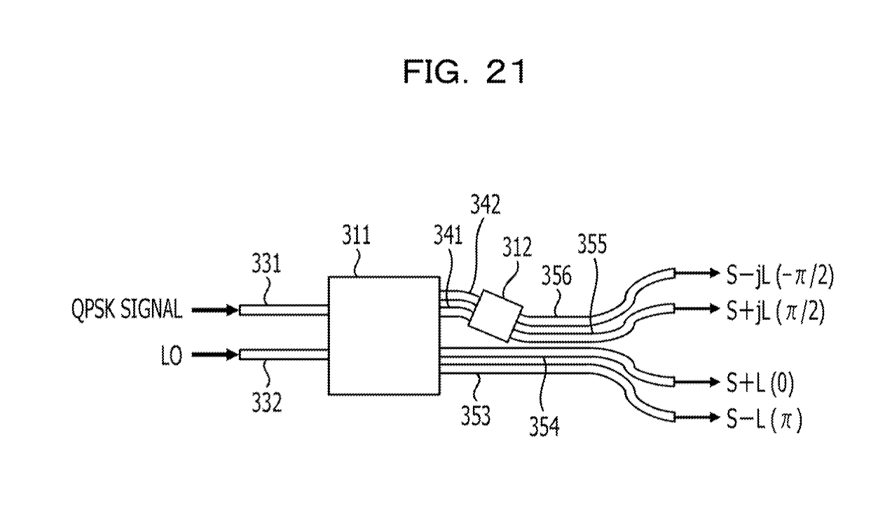

First, a 90-degree hybrid structured as illustrated in FIG. 21 includes the 2×4 MMI coupler 311 and the 2×2 MMI coupler 312. Optical waveguides 341 and 342 provided between the 2×4 MMI coupler 311 and the 2×2 MMI coupler 312 are formed to be structured in the same way as the optical waveguides 21 and 22, respectively, according to the first embodiment. Further, the optical waveguides 331 and 332 are coupled to the input side of the 2×4 MMI coupler 311, and optical waveguides 341, 342, 353, and 354 are coupled to the output side of the 2×4 MMI coupler 311. Also, the optical waveguides 341 and 342 are coupled to the input side of the 2×2 MMI coupler 312, and optical waveguides 355 and 356 are coupled to the output side of the 2×2 MMI coupler 312. The optical waveguide 342 is formed to be delayed by π/4 with respect to the optical waveguide 341. That is, in the 2×4 MMI coupler 311, the optical waveguide 341 serving as the first optical waveguide is provided on the inner side with respect to the optical waveguide 342 serving as the second optical waveguide, and the optical waveguide 342 is formed to be longer than the optical waveguide 341 so as to cause a phase difference of π/4. In the 90-degree hybrid, a signal with a phase difference of π is output to the optical waveguide 353, a signal with no phase difference is output to the optical waveguide 354, a signal with a phase difference of π/2 is output to the optical waveguide 355, and a signal with a phase difference of −π/2 is output to the optical waveguide 356. Thus, by coupling the 2×2 MMI coupler 312 at a different position, a 90-degree hybrid with a high fabrication tolerance may be obtained. The optical waveguides 353 and 354 are equivalent to the fifth optical waveguide and the sixth optical waveguide, respectively, and the optical waveguides 355 and 356 are equivalent to the seventh optical waveguide and the eighth optical waveguide, respectively.

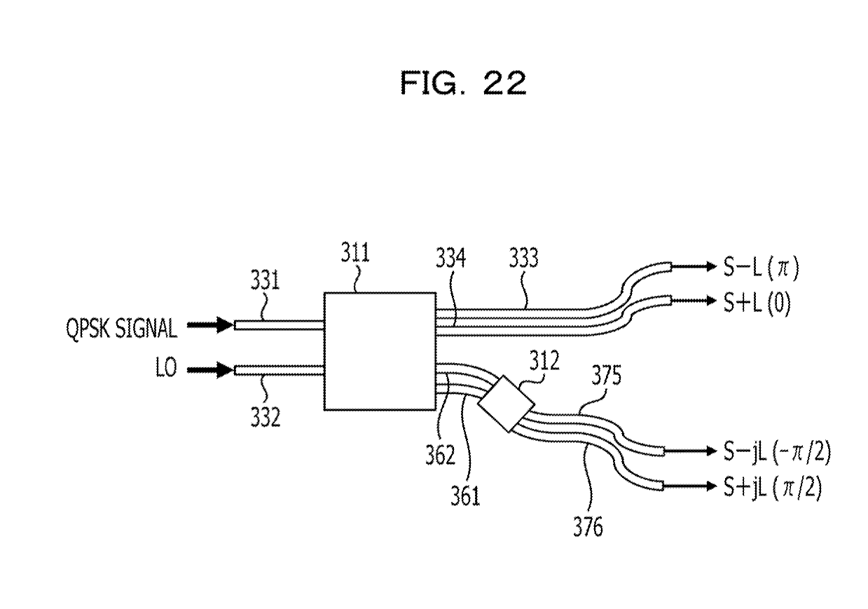

Next, a 90-degree hybrid structured as illustrated in FIG. 22 includes the 2×4 MMI coupler 311 and the 2×2 MMI coupler 312. Optical waveguides 361 and 362 provided between the 2×4 MMI coupler 311 and the 2×2 MMI coupler 312 are formed to be structured in the same way as the optical waveguides 21 and 22, respectively, according to the first embodiment. Further, the optical waveguides 331 and 332 are coupled to the input side of the 2×4 MMI coupler 311, and optical waveguides 361, 362, 333, and 334 are coupled to the output side of the 2×4 MMI coupler 311. Also, the optical waveguides 361 and 362 are coupled to the input side of the 2×2 MMI coupler 312, and optical waveguides 375 and 376 are coupled to the output side of the 2×2 MMI coupler 312. The optical waveguide 362 is formed to be delayed by 3π/4 with respect to the optical waveguide 361. That is, in the 2×4 MMI coupler 311, the optical waveguide 361 serving as the first optical waveguide is provided on the outer side with respect to the optical waveguide 362 serving as the second optical waveguide, and the optical waveguide 362 is formed to be longer than the optical waveguide 361 so as to cause a phase difference of 3π/4. The phase difference may be (2n+¾)π (n is 0 or a natural number), which results in a phase difference of 3π/4. In the 90-degree hybrid, a signal with a phase difference of π is output to the optical waveguide 333, a signal with no phase difference is output to the optical waveguide 334, a signal with a phase difference of −π/2 is output to the optical waveguide 375, and a signal with a phase difference of π/2 is output to the optical waveguide 376. Thus, by changing the direction of the bent waveguide in each of the optical waveguides 361 and 362, the optical waveguides 361 and 362 and the optical waveguides 333 and 334 can be disposed without contacting each other in addition to achieving the effect discussed above. This allows the optical waveguides 361, 362, 333, and 334 to be disposed with a higher density. The optical waveguides 375 and 376 are equivalent to the seventh optical waveguide and the eighth optical waveguide, respectively.

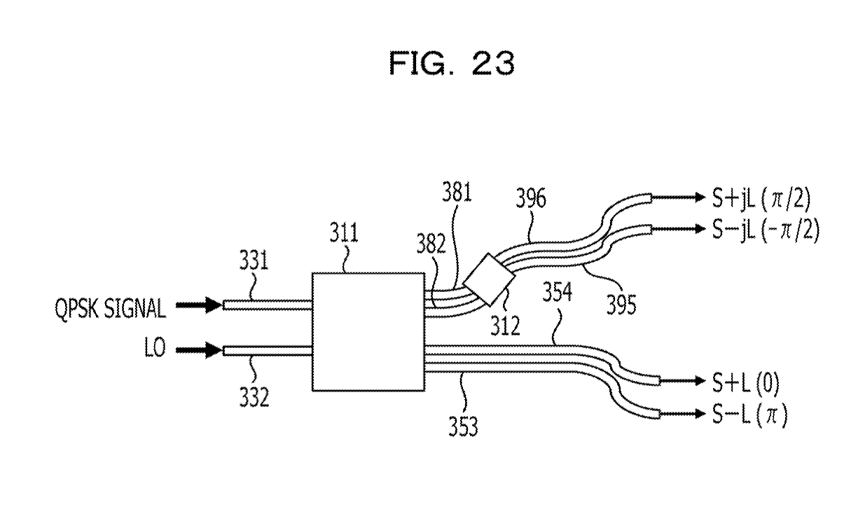

Moreover, a 90-degree hybrid structured as illustrated in FIG. 23 includes the 2×4 MMI coupler 311 and the 2×2 MMI coupler 312. Optical waveguides 381 and 382 provided between the 2×4 MMI coupler 311 and the 2×2 MMI coupler 312 are formed to be structured in the same way as the optical waveguides 21 and 22, respectively, according to the first embodiment. Further, the optical waveguides 331 and 332 are coupled to the input side of the 2×4 MMI coupler 311, and optical waveguides 381, 382, 353, and 354 are coupled to the output side of the 2×4 MMI coupler 311. Also, the optical waveguides 381 and 382 are coupled to the input side of the 2×2 MMI coupler 312, and optical waveguides 395 and 396 are coupled to the output side of the 2×2 MMI coupler 312. The optical waveguide 382 is formed to be delayed by 3π/4 with respect to the optical waveguide 381. That is, in the 2×4 MMI coupler 311, the optical waveguide 381 serving as the first optical waveguide is provided on the outer side with respect to the optical waveguide 382 serving as the second optical waveguide, and the optical waveguide 382 is formed to be longer than the optical waveguide 381 so as to cause a phase difference of 3π/4. In the 90-degree hybrid, a signal with a phase difference of π is output to the optical waveguide 353, a signal with no phase difference is output to the optical waveguide 354, a signal with a phase difference of −π/2 is output to the optical waveguide 395, and a signal with a phase difference of π/2 is output to the optical waveguide 396. According to the thus structured 90-degree hybrid, an effect similar to that obtained with the 90-degree hybrid structured as illustrated in FIG. 22 can be obtained. The optical waveguides 395 and 396 are equivalent to the seventh optical waveguide and the eighth optical waveguide, respectively.

The method of manufacturing the optical waveguide element according to the embodiment and so forth are the same as those according to the first embodiment.

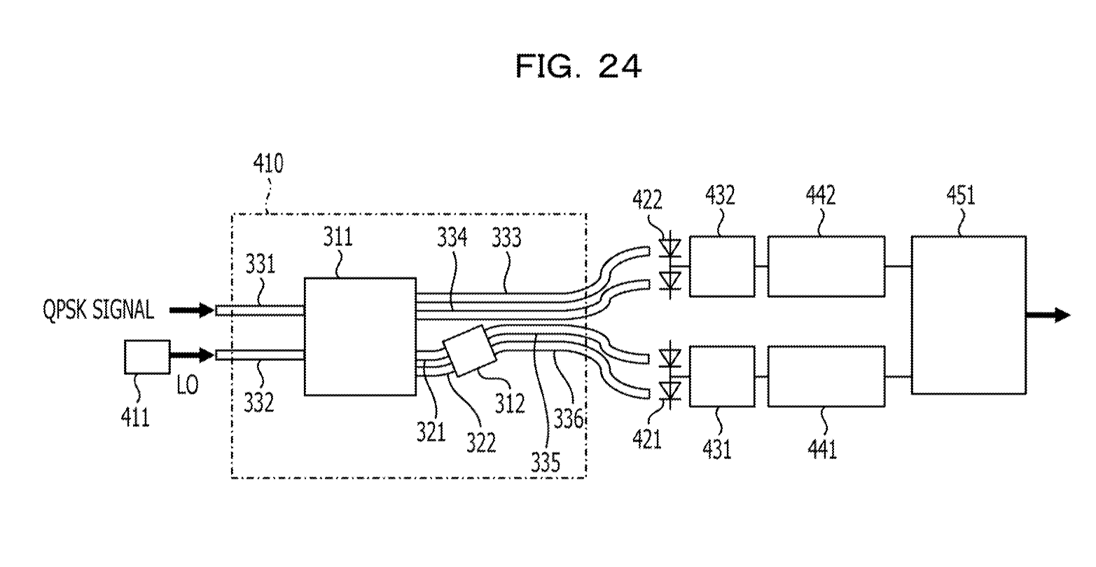

Next, a third embodiment will be described. As illustrated in FIG. 24, the embodiment provides a coherent optical receiver. The coherent optical receiver according to the embodiment includes a 90-degree hybrid 410, an LO light source 411, balanced photodiodes 421 and 422, trans-impedance amplifiers 431 and 432, A/D conversion circuits 441 and 442, and a digital signal processing circuit 451.

The 90-degree hybrid 410 is formed by any of the 90-degree hybrids according to the second embodiment. In FIG. 24, one of the 90-degree hybrids according to the second embodiment is illustrated as an example. The LO light source 411 emits LO light to the 90-degree hybrid 410. The balanced photodiodes (BPDs) 421 and 422 detect an optical signal from the 90-degree hybrid 410. The trans-impedance amplifiers (TIAs) 431 and 432 convert a current signal into a voltage signal. The A/D conversion circuits 441 and 442 convert an input analog signal into a digital signal.

In the coherent optical receiver according to the embodiment, when LO light temporally synchronized with QPSK signal light (QPSK signal pulse) is incident into the 90-degree hybrid 410, the 90-degree hybrid 410 splits the LO light to output four types of signal light with various phases. The signal light is detected by the balanced photodiodes 421 and 422 coupled to receive an in-phase signal and an orthogonal signal, respectively. Each of the balanced photodiodes 421 and 422 includes two photodiodes, which are configured to allow a current equivalent to 1 or −1 to flow in the case where signal light is incident into one of the photodiodes, and not to allow a current to flow in the case where signal light is incident into the photodiodes at the same time. Thus, it is possible to identify information on the phase of the QPSK signal light. The optical signal detected by the balanced photodiodes 421 and 422 is converted into a current signal, which is converted by the trans-impedance amplifiers 431 and 432 into an analog voltage signal, which is converted by the A/D conversion circuits 441 and 442 into a digital signal. Thereafter, the digital signal processing circuit 451 performs signal processing on the digital signal, which completes the function as the coherent optical receiver.

Next, a fourth embodiment will be described. The embodiment provides a 90-degree hybrid that handles differential quadrature phase shift keying (DQPSK1) signal light. Specifically, while the 90-degree hybrid according to the second embodiment receives QPSK signal light and LO light at the same time, the 90-degree hybrid according to the embodiment receives differential quadrature phase shift keying signal light. This eliminates the need for LO light, and therefore eliminates the need for an LO light source.

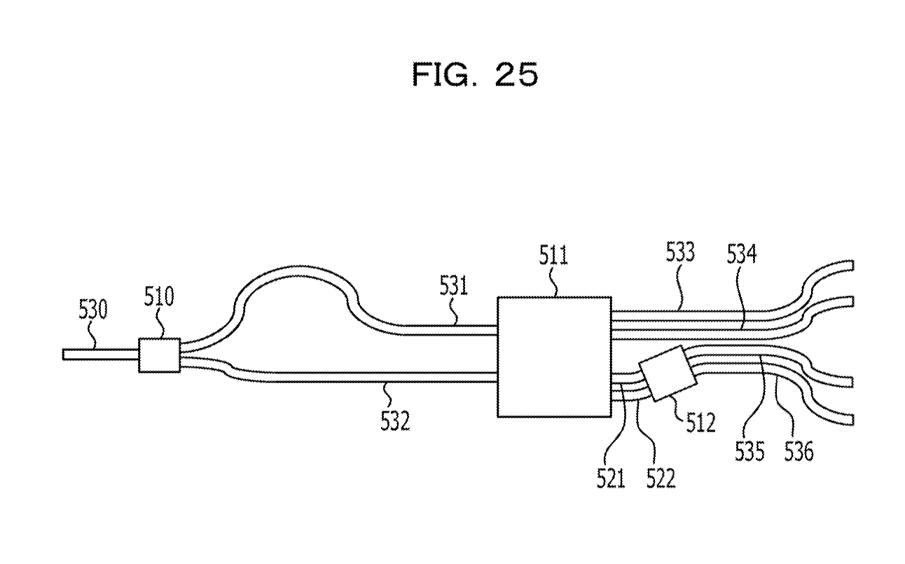

As illustrated in FIG. 25, the 90-degree hybrid according to the embodiment includes a 1×2 MMI coupler 510 serving as a third optical coupler, a 2×4 MMI coupler 511 serving as the first optical coupler, and a 2×2 MMI coupler 512 serving as the second optical coupler. An optical waveguide 530 serving as a ninth optical waveguide is coupled to the input side of the 1×2 MMI coupler 510, and optical waveguides 531 and 532 serving as the third optical waveguide and the fourth optical waveguide, respectively, are coupled to the output side of the 1×2 MMI coupler 510. The optical waveguides 531 and 532 are coupled to the input side of the 2×4 MMI coupler 511, optical waveguides 521 and 522 serving as the first optical waveguide and the second optical waveguide, respectively, and optical waveguides 533 and 534 serving as the fifth optical waveguide and the sixth optical waveguide, respectively, are coupled to the output side of the 2×4 MMI coupler 511. The optical waveguides 521 and 522 are coupled to the input side of the 2×2 MMI coupler 512, and optical waveguides 535 and 536 serving as a seventh optical waveguide and an eighth optical waveguide, respectively, are coupled to the output side of the 2×2 MMI coupler 512. Here, an assembly formed by the 2×4 MMI coupler 511, the 2×2 MMI coupler 512, and the optical waveguides 521, 522, 531, 532, 533, 534, 535, and 536 are similar to the 90-degree hybrid according to the second embodiment, and has a similar function. The optical waveguide 531 formed between the 1×2 MMI coupler 510 and the 2×4 MMI coupler 511 is formed to be delayed by one bit of the DQPSK signal with respect to the optical waveguide 532.

When DQPSK signal light is input to the input side of the 1×2 MMI coupler 510, the 1×2 MMI coupler 510 splits the DQPSK signal light into two parts, which are output to the optical waveguides 531 and 532 to be input to the 2×4 MMI coupler 511. As discussed above, the 2×2 MMI coupler 511 receives through the optical waveguide 531 an optical signal delayed by one bit with respect to that of the optical waveguide 532. Therefore, the optical signals input to the 2×4 MMI coupler 511 through the optical waveguides 531 and 532 are temporally synchronized with each other. Accordingly, an optical signal with a phase difference of π is output to the optical waveguide 533, an optical signal with no phase difference is output to the optical waveguide 534, an optical signal with a phase difference of π/2 is output to the optical waveguide 535, and an optical signal with a phase difference of −π/2 is output to the optical waveguide 536. In the embodiment, the manufacturing margin can be increased in the same way as in the second embodiment, and therefore the fabrication tolerance can be improved.

In the above description, the 1×2 MMI coupler 510 is used. However, a Y-branch coupler, a 2×2 MMI coupler, or a 2×2 directional coupler may be used in place of the 1×2 MMI coupler 510 to obtain a similar 90-degree hybrid.

Details other than those described above are the same as the details of the first embodiment and the second embodiment.

Next, a fifth embodiment will be described. The embodiment provides an optical receiver including the 90-degree hybrid according to the fourth embodiment.

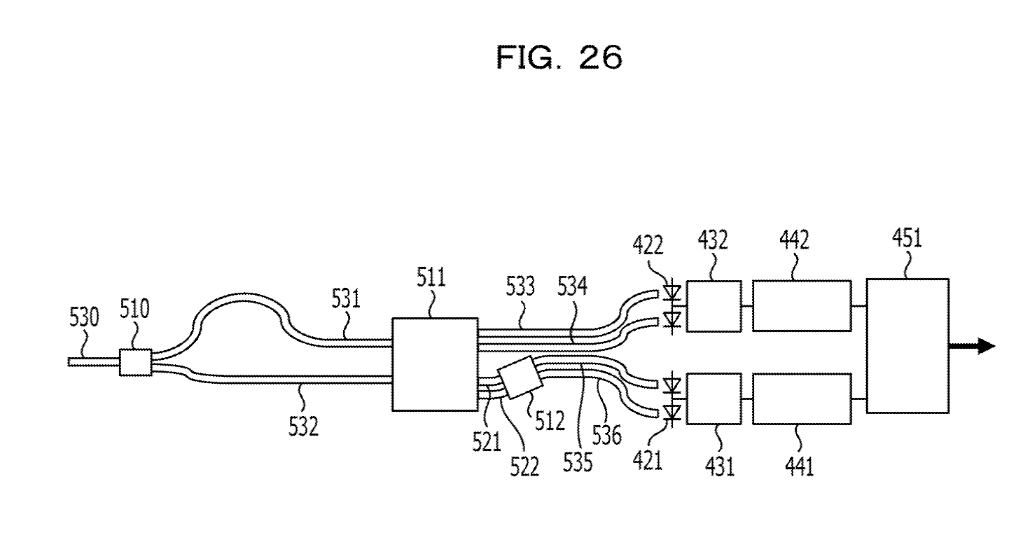

The optical receiver according to the embodiment will be described with reference to FIG. 26. The optical receiver according to the embodiment includes the 90-degree hybrid according to the fourth embodiment, and the balanced photodiodes 421 and 422, the trans-impedance amplifiers 431 and 432, the A/D conversion circuits 441 and 442, and the digital signal processing circuit 451 coupled to the 90-degree hybrid. The balanced photodiodes 421 and 422, the trans-impedance amplifiers 431 and 432, the A/D conversion circuits 441 and 442, and the digital signal processing circuit 451 are the same as those according to the third embodiment.

In the optical receiver according to the embodiment, when DQPSK signal light is input to the optical waveguide 530, the 1×2 MMI coupler 510 splits the DQPSK signal light into two parts, which are input via the optical waveguides 531 and 532 to the 2×4 MMI coupler 511. As discussed above, the 2×2 MMI coupler 511 receives through the optical waveguide 531 an optical signal delayed by one bit with respect to that of the optical waveguide 532. Therefore, the optical signals input to the 2×4 MMI coupler 511 through the optical waveguides 531 and 532 are temporally synchronized with each other. Accordingly, an optical signal with a phase difference of π, an optical signal with no phase difference, an optical signal with a phase difference of π/2, and an optical signal with a phase difference of −π/2 are output to the optical waveguides 533, 534, 535, and 536, respectively, to be detected by the balanced photodiodes 421 and 422. In this way, an optical receiver that can identify a DQPSK modulation signal can be obtained.

Details other than those described above are the same as the details of the third embodiment.

While embodiments have been described in detail above, such specific embodiments are not limiting, and various modifications and alterations may be made without departing from the scope of the claims.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. An optical waveguide element comprising:
a first optical coupler;
a second optical coupler; and
a first optical waveguide and a second optical waveguide that couple an output side of the first optical coupler and an input side of the second optical coupler to each other,
the first optical waveguide and the second optical waveguide each include a bent waveguide, and
the first optical waveguide and the second optical waveguide are different in optical path length from each other.

2. The optical waveguide according to claim 1,
wherein a center of a circle drawn with a radius of curvature of the bent waveguide of the first optical waveguide coincides with a center of a circle drawn with a radius of curvature of the bent waveguide of the second optical waveguide.

3. The optical waveguide according to claim 2,
wherein an average radius of curvature R₀ which is an average of the radius of curvature R₁ of the bent waveguide of the first optical waveguide and the radius of curvature R₂ of the bent waveguide of the second optical waveguide is 100 μm or more.

4. The optical waveguide according to claim 1,
wherein the first optical waveguide further includes a straight waveguide.

5. The optical waveguide according to claim 1,
wherein the second optical waveguide further includes a straight waveguide.

6. The optical waveguide according to claim 1,
wherein a stepped section in which a center of the straight waveguide and a center of the bent waveguide are offset from each other is provided at a section of coupling between the straight waveguide and the bent waveguide.

7. The optical waveguide according to claim 1,
wherein the first optical waveguide and the second optical waveguide are formed by a core layer including GaInAsP and formed on a substrate including InP, and a clad layer including InP and formed on the core layer.

8. The optical waveguide according to claim 1,
wherein the first optical coupler is one of a 1×2 optical coupler, a 2×2 optical coupler, and a 2×4 optical coupler.

9. The optical waveguide according to claim 1,
wherein the second optical coupler is a 2×2 optical coupler.

10. The optical waveguide according to claim 8,
wherein the first optical coupler is an MMI coupler.

11. The optical waveguide according to claim 8,
wherein the second optical coupler is an MMI coupler.

12. An optical hybrid circuit comprising:
a first optical coupler;
a second optical coupler; and
a first optical waveguide and a second optical waveguide that couple an output side of the first optical coupler and an input side of the second optical coupler to each other,
the first optical waveguide and the second optical waveguide each include a bent waveguide,
the first optical waveguide and the second optical waveguide are different in optical path length from each other,
the first optical coupler is a 2×4 optical coupler,
the second optical coupler is a 2×2 optical coupler, and
the optical hybrid circuit further includes
a third optical waveguide and a fourth optical waveguide coupled to an input side of the first optical coupler,
a fifth optical waveguide and a sixth optical waveguide coupled to the output side of the first optical coupler, and
a seventh optical waveguide and an eighth optical waveguide coupled to an output side of the second optical coupler.

13. The optical hybrid circuit according to claim 12,
wherein a difference between a length of the first optical waveguide and a length of the second optical waveguide is equivalent to a phase difference of (2n+¼)π or (2n+¾)π (n is 0 or a natural number) of light at a wavelength input to the first optical waveguide and the second optical waveguide.

14. The optical hybrid circuit according to claim 13,
wherein in the case where the first optical waveguide is provided on an inner side with respect to the second optical waveguide on the output side of the 2×4 optical coupler serving as the first optical coupler, the second optical waveguide is formed to be longer than the first optical waveguide by (n+44), and
in the case where the second optical waveguide is provided on an inner side with respect to the first optical waveguide on the output side of the 2×4 optical coupler serving as the first optical coupler, the second optical waveguide is formed to be longer than the first optical waveguide by (n+3π/4).

15. The optical hybrid circuit according to claim 12,
wherein local oscillator light is input to one of the third optical waveguide and the fourth optical waveguide, and QPSK signal light is input to the other,
the fifth optical waveguide and the sixth optical waveguide output an in-phase signal, and
the seventh optical waveguide and the eighth optical waveguide output an quadrature signal.

16. The optical hybrid circuit according to claim 12, further comprising:
a third optical coupler which is formed by a 1×2 optical coupler and is coupled to an input side of which a ninth optical waveguide,
wherein the third optical waveguide and the fourth optical waveguide are coupled to an output side of the third optical coupler, and
one of the third optical waveguide and the fourth optical waveguide is formed to be longer than the other by a length equivalent to one cycle of a bit rate of signal light input to the ninth optical waveguide.

17. The optical hybrid circuit according to claim 16,
wherein a DQPSK signal is input to the ninth optical waveguide,
the fifth optical waveguide and the sixth optical waveguide output an in-phase signal, and
the seventh optical waveguide and the eighth optical waveguide output an quadrature signal.

18. An optical receiver comprising:
a first optical coupler;
a second optical coupler;
a first optical waveguide and a second optical waveguide that couple an output side of the first optical coupler and an input side of the second optical coupler to each other;
a third optical waveguide and a fourth optical waveguide coupled to an input side of the first optical coupler;
a fifth optical waveguide and a sixth optical waveguide coupled to the output side of the first optical coupler;
a seventh optical waveguide and an eighth optical waveguide coupled to an output side of the second optical coupler;
two detection sections that detect an in-phase signal and an orthogonal signal from the fifth optical waveguide, the sixth optical waveguide, the seventh optical waveguide, and the eighth optical waveguide; and
a digital signal processing circuit coupled to the detection sections,
the first optical waveguide and the second optical waveguide each include a bent waveguide,
the first optical waveguide and the second optical waveguide are different in optical path length from each other,
the first optical coupler is a 2×4 optical coupler,
the second optical coupler is a 2×2 optical coupler,
local oscillator light is input to one of the third optical waveguide and the fourth optical waveguide, and QPSK signal light is input to the other,
the fifth optical waveguide and the sixth optical waveguide output an in-phase signal, and
the seventh optical waveguide and the eighth optical waveguide output an orthogonal signal.

19. The optical receiver according to claim 18,
wherein the detection sections each include a balanced photodiode that detects the in-phase signal and the quadrature signal.

20. The optical receiver according to claim 19,
wherein the detection sections each include
a trans-impedance amplifier coupled to the balanced photodiode, and
an A/D conversion circuit coupled to the trans-impedance amplifier, and
the A/D conversion circuit in each of the detection sections is coupled to the digital signal processing circuit.
